(19) United States
(12) Patent Application Publication
(10) Pub. No.: US 2006/0159141 A1
(43) Pub. Date: Jul. 20, 2006

(54) Optical transmitting module operable in wide temperature range

(75) Inventors: Kenichiro Uchida, Kanagawa (JP); Moriyiasu Ichino, Kanagawa (JP); Toru Kawagishi, Kanagawa (JP)

Correspondence Address: VENABLE LLP, P.O. BOX 34385, WASHINGTON, DC, 20045-9998, US

(73) Assignee: Sumitomo Electric Industries, Ltd., Osaka (JP)

(21) Appl. No.: 11/335,700

(22) Filed: Jan. 20, 2006

(30) Foreign Application Priority Data
Jan. 20, 2005 (JP) 2005-013246

(51) Int. Cl. H01S 3/04

(52) U.S. Cl. 372/34; 372/38.01; 372/29.011

(57) ABSTRACT

The present invention relates to an optical transmitting module that reduces the deviation of the emission wavelength even in a wide range of the operating temperature. The module comprises a laser diode (LD), a Peltier element to control the temperature of the LD, a first sensor to sense the temperature of the LD, a second sensor to sense the ambient temperature, a reference generator, and a Peltier driver. The reference generator, based on the ambient temperature, generates a reference signal to the Peltier drive such that the operating range of the LD becomes smaller than the range of the ambient temperature.

### BACKGROUND OF THE INVENTION

1. Field of the Invention

The present invention relates to an optical transmitting module.

2. Related Prior Art

The optical transmitting module has been applied in the optical communication system, in which the module converts an electrical signal inputted therein into a corresponding optical signal to output in an optical transmitting medium such as an optical fiber. In the wavelength division multiplexing (WDM) system, which is one type of intelligent optical communication systems to send a large capacity of information, a plurality of optical transmitting modules simultaneously outputs a plurality of optical signals each having a specific wavelength, therefore, it is strongly requested for the wavelength of the optical signal to show quite high accuracy and stability even when environment conditions, such as an ambient temperature, are varied.

One solution for solving the above subject has been disclosed in Japanese Patent published as JP-2003-273447A. The optical transmitting module disclosed in this patent document controls in feedback the current supplied to the Peltier element that mounts the laser diode (hereinafter denoted as LD) thereon to adjust the temperature thereof, based on the preset value that corresponds to the desired temperature of the Peltier element. Thus, the temperature of the LD may be kept constant regardless of the ambient temperature.

However, in the WDM system, components or equipments used therein require a performance to be operable in a wide temperature range from −40° C. to +85° C. When the conventional optical transmission module is applied to such WDM system, the maximum range of the ambient temperature, that means the maximum operable range in the temperature, becomes 125° C. The Peltier element has a paired plates, one is cooled down while the other is heated up by supplying a driving current thereto. The direction of the current determines the operational mode of the Peltier element, namely, whether the target plate is cooled down or heated up. In the optical transmitting module, the LD is mounted on one plate of the Peltier element, while the other plate is thermally coupled with the ambient. Therefore, by supplying the driving current to the Peltier element, the LD mounted thereon is cooled down or heated up.

However, the Peltier element generally shows an operating limit of about 50° C. between two plates. That is, when one of plates is exposed to the ambient, the other plate is restricted to be controlled in the temperature thereof within +/−50° C. with respect to the ambient temperature. Therefore, when the temperature of the LD should be kept constant at 40° C., it is barely able to control the temperature of the LD when the ambient temperature is 85° C., the upper limit of the WDM system, while it is unable to control when the ambient temperature is −40° C., the lower limit of the standard of the WDM system.

When no temperature control is performed for the LD, various problems may occur. That is, in the coarse wavelength division multiplexing system (CWDM system), which is one type of the WDM communication system, a wavelength interval between signal channels is set to be 10 nm. On the other hand, the temperature dependence of the emission wavelength from the LD becomes about +0.1 nm/° C. even for a LD with the distributed feedback (DFB) type, which stably oscillates in a single mode and shows a quite sharp emission spectrum. Therefore, the optical transmitting module without any temperature control function for the LD shows a deviation of the emission wavelength of about 12.5 nm within a whole operable range of the ambient temperature, which exceeds the CWDM standard.

### SUMMARY OF THE INVENTION

One aspect of the present invention relates to an optical transmitting module. The module comprises a laser diode (LD), a Peltier element, first and second temperature sensors, a Peltier driver, and a reference generator. The laser diode emits light with an emission wavelength. The first temperature sensor senses a current temperature of the LD, while the second temperature sensor senses the ambient temperature of the module. The reference generator calculates a reference temperature, to which the temperature of the LD is adjusted, by receiving the ambient temperature from the second sensor. The Peltier driver drivers the Peltier element by (1) receiving the current temperature of the LD and the reference temperature from the reference generator, (2) comparing these temperatures, and (3) outputting a driving current to the Peltier element such that a difference between these temperatures disappear, that is, the current temperature becomes equal to the reference temperature, by adjusting the magnitude of the driving current and its direction.

Since the present optical module senses the ambient temperature and determines the reference temperature of the LD based on this sensed ambient temperature, a range of the reference temperature may be smaller than an operable range of the ambient temperature. That is, even the ambient temperature has a wide operable range of 125° C., from −40° C. to +85° C., the reference temperature of the LD may be set in a smaller range. It is preferable to set the range of the reference temperature is 100° C., because the LD is operated within this temperature range, the shift of the emission wavelength thereof may be kept within 10 nm, which satisfies the course wavelength division multiplexing system. Moreover, it is further preferable to set the difference between the reference temperature and the ambient temperature smaller than 50° C., which can protect the Peltier element from the thermal runway.

Another aspect of the present invention relates to a method to control the temperature of the LD. The method comprises steps of: (a) sensing a current temperature of the LD by the first sensor; (b) sensing an ambient temperature of the module by the second sensor; (c) calculating a reference temperature of the LD such that a range of the reference temperature is smaller than a range of the ambient temperature; (d) comparing the reference temperature with the current temperature; and (e) driving the Peltier element to disappear the difference between the reference temperature and the ambient temperature. In another mode of the method according to the present invention, the step (c) comprises to calculate a reference temperature of the LD such that the difference from the ambient temperature becomes smaller than 50° C.

### BRIEF DESCRIPTION OF DRAWINGS

FIG. 1 is a block diagram of the present optical transmitting module;

FIG. 2A shows a relation of the reference temperature generated by the reference generator shown in FIG. 1 to the ambient temperature, and FIG. 2B shows a relation of the driving current generated by the Peltier driver shown in FIG. 1 to the ambient temperature;

FIG. 3A shows a relation between the output power and the driving current of the LD when the temperature thereof is varied, and FIG. 3B shows a relation between the bias current and the temperature of the LD;

FIGS. 4A to 4C show relations of the temperature of the LD, the driving current for the Peltier element, and the emission wavelength of the LD to the ambient temperature, respectively;

FIG. 5 is the relation between the bias current and the temperature of the LD; and

FIG. 6 shows a block diagram of the conventional transmitting module.

### DESCRIPTION OF PREFERRED EMBODIMENTS

Next, preferred embodiments of the present invention will be described as referring to accompanying drawings. In the description below, same numerals or symbols will refer to same elements without overlapping explanations.

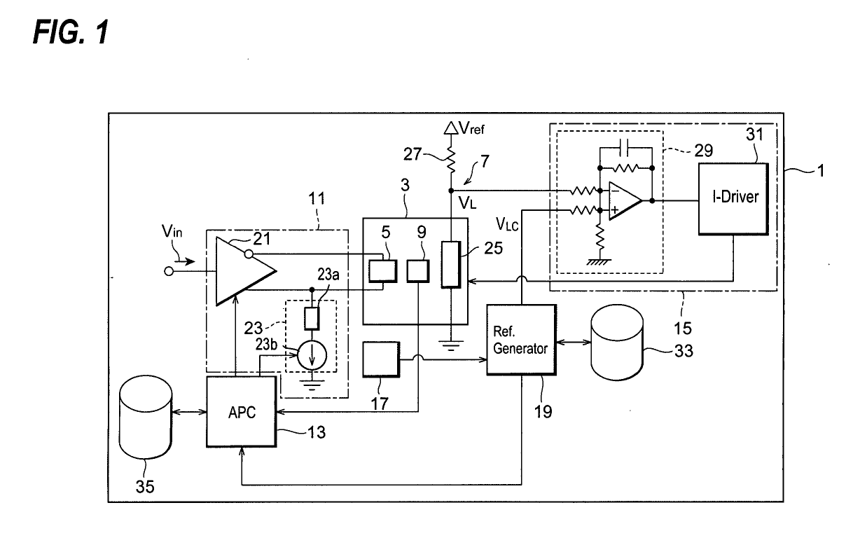

FIG. 1 is a block diagram of an optical transmitting module according to the present embodiment. The optical transmitting module 1 shown in FIG. 1 is configured to receive an electrical signal Vin, to convert it into a corresponding optical signal, and to send this optical signal in an optical propagating medium such as an optical fiber not shown in FIG. 1. The optical module 1 comprises: a laser diode (LD) 5 mounted on the Peltier element 3, a first temperature sensor 7 installed immediate to the LD 5, a photodiode 9 for monitoring light emitted from the LD 5, an automatic power control (hereinafter denoted as APC) circuit 13 to adjust bias and modulation currents to be supplied to the LD 5, a driver 11 to supply the bias and modulation current to the LD 5, a Peltier driver 15 to control the driving current supplied to the Peltier element 3, a second temperature sensor 17 for sensing the ambient temperature, and a reference generator 19 to output a reference signal to the Peltier driver 15 to control the temperature of the Peltier element 3.

The driver 11, connected to the LD 5, supplies the bias current I_{B} and the modulation current I_{M} to the LD 5. The driver 11 includes a first section 21 to modulate the modulation current I_{M} and a second section 23, including a constant current source 23a and an inductor 23b, to generate the bias current I_{B}.

On the Peltier element 3 is mounted with the LD 5. By supplying the driving current to the Peltier element 3, the LD may be cooled down or heated up to vary the temperature thereof. The mode whether the LD is cooled down or heated up may be determined by the direction of the driving current.

Immediate to the LD 5 and on the Peltier element 3 is mounted with a thermistor 25 as the first temperature sensor 7. By dividing the constant voltage Vref with the thermistor 25 and a resistor 27, the resistance of the thermistor widely changes, a voltage signal V_{L} that corresponds to the temperature of the Peltier element 3 and nearly equal to that of the LD is output to the Peltier driver 15 as the current temperature signal.

The Peltier driver 15 supplies the driving current to the Peltier element 3 so as to keep the current temperature of the LD 5 constant. This Peltier driver 15 includes the automatic temperature control (hereinafter denoted as ATC) circuit 29 and the current driver 31. The ATC circuit 29 receives the current temperature signal V_{L} from the first temperature sensor 7 and the reference signal V_{LC} from the reference generator 19, and outputs a signal so as to equalize these input signals, V_{L} and V_{LC}, namely, to close the current temperature signal V_{L} to the reference signal V_{LC}. The current driver 31 converts this signal output from the ATC circuit 29 into the driving current and determines the direction of this driving current. The current driver 31 may operate in the PID control, the PI control and the switching control of the current to the Peltier element.

The optical module 1 further provides the second temperature sensor 17 configured to monitor the ambient temperature of the module 1 and to output the reference signal. A thermistor and a junction diode may be available for the second temperature sensor 17. This second temperature sensor 17 is preferable to be installed within the module apart from the LD 5 or the Peltier element 3 so as not to be affected from the Peltier element 3.

The reference generator 19 calculates the reference temperature T_{LC} from the ambient temperature T^{(amb)} sensed by the second sensor 17. For example, the following function may be applicable for the calculation;
T_{LC}=T^{(ref)}+α×(T^{(amb)}−T^{(ref)}),
where T^{(ref)} denotes the temperature at which the reference temperature becomes equal to the ambient temperature T^{(amb)}.

A parameter α may be a positive number. The reference temperature T_{LC} may be calculated from the ambient temperature T^{(amb)} so as to narrow the range of the reference temperature T_{LC} for the LD smaller than that of the ambient temperature T^{(amb)}. The temperature difference between two plates of the Peltier element should be smaller than 50° C., and one plate is exposed to the ambient while the other plate mounts the LD. Therefore, from the function above, this relation of the temperatures of two plates of the Peltier element 3 becomes;
|T^{(ref)}+α×(T^{(amb)}−T^{(ref)})−T^{(amb)}|<=50° C.,
that is;
1-50/|T^{(ref)}−T^{(amb)}|<=α
Under an extreme condition, namely, T^{(ref)} is set to be the uppermost or lowermost within the range of the ambient temperature and the ambient temperature becomes the lowermost or uppermost temperature within the range, the value |T^{(ref)}−T^{(amb)}| becomes 125° C., then, a condition of α>=3/5 can be obtained. This case reflects the extreme conditions that T^{(ref)} is set to be 125° C. or −40° C. While, under normal conditions that T^{(ref)} is set in a room temperature, typically in a range from 10° C. to 40° C., a preferable range of α>=2/5 may be obtained.

Moreover, it is further preferable that the parameter a becomes smaller than or equal to 4/5, α<=4/5, because the range of the temperature of the LD T_{LC} becomes smaller than 100° C., accordingly, the shift of the emission wavelength of the LD, specifically for the DFB-LD with the temperature coefficient of 0.1 nm/° C. for the emission wavelength, may be compressed smaller than an interval of the CWDM standard, which is 10 nm.

The reference generator 19 may calculate the reference temperature TLC based on the ambient temperature T^{(amb)} by using data stored in the memory 33 such as a read only memory (ROM). For example, the reference generator 19 reads the parameters, α and T^{(ref)}, from the memory 33 and calculates the reference temperature T_{LC} by using these parameters according to the above function. Or, the reference temperature T_{LC} may be obtained by reading data configured in a look-up-table within the memory 33 that relates the reference temperature T_{LC} with respect to the ambient temperatures. After obtaining the reference temperature TLC, the reference generator 19 converts it into a voltage value V_{LC} and not only outputs this voltage V_{LC} to the ATC circuit 29 of the Peltier driver 15 but also sends the reference temperature T_{LC} to the APC circuit 13.

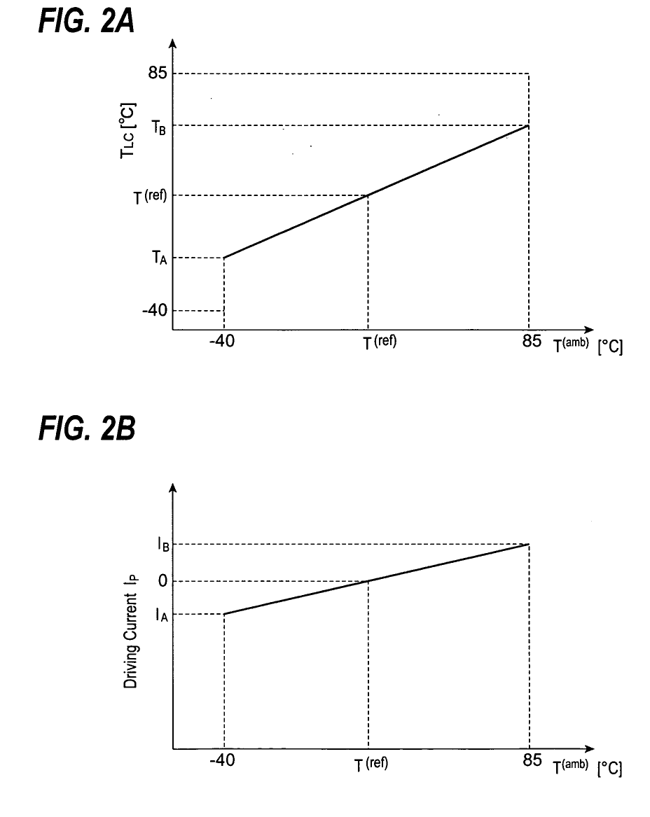

FIG. 2A shows a relation between the ambient temperature T^{(amb)} and the reference temperature T_{LC} calculated in the reference generator 19, while FIG. 2B shows a relation between the ambient temperature T^{(amb)} and the driving current I_{P} generated by the Peltier driver 15. As shown in FIG. 2A, when the ambient temperature T^{(amb)} varies from −40° C. to +85° C., the reference temperature T_{LC} is controlled to vary within a range from T_{A} to T_{B} that is narrower than the range of the ambient temperature T^{(amb)}. Moreover, at the condition of T^{(amb)}=T^{(ref)}, the reference temperature T_{LC} becomes equal to the ambient temperature T^{(amb)}.

The voltage signal V_{LC} is output to the Peltier driver 15 from the reference generator 19, the Peltier driver 15 controls the driving current I_{P} such that the current temperature of the LD sensed by the first sensor 7 becomes equal to the reference temperature T_{LC}. For example, as shown in FIG. 2B, the Peltier driver 15 controls the driving current I_{P} within in a range form I_{A} to I_{B} (I_{A}<0<I_{B}) when the ambient temperature T^{(amb)} varies from −40° C. to 85° C.

On the Peltier element 3 is mounted with a photodiode 9 for monitoring light emitted from the back facet of the LD 5. This photodiode 9 converts the optical signal from the LD 5 into a current signal and outputs it to the APC circuit 13. The APC circuit 13, based on this current signal, adjusts the modulation current I_{M} and the bias current I_{B} to keep the magnitude of the current signal constant.

The APC circuit 13 also adjusts the bias current I_{B} based on the reference temperature T_{LC} sent from the reference generator 19. That is, the APC circuit 13 determines the bias current I_{B} by accessing the memory 35 in which the relation between the bias current I_{B} and the reference temperature T_{LC} of the LD is stored. In this case, the data stored in the memory 35 may be a set of coefficients of a function that gives a relation between the bias current I_{B} and the reference temperature T_{LC}, or may have a configuration of a look-up-table.

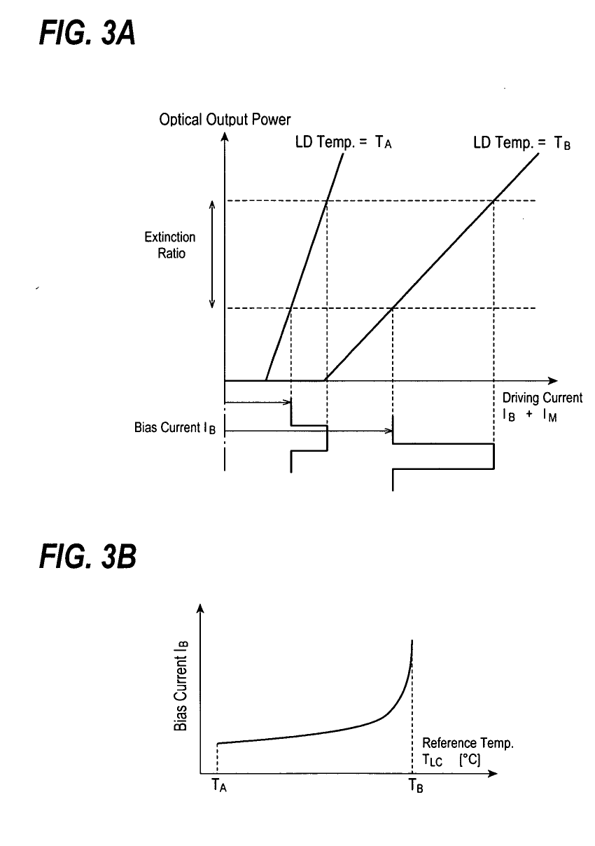

Referring to FIG. 3, the relation between the reference temperature TLC and the bias current I_{B} will be described below. FIG. 3A shows a relation between the output power from the LD 5 and the driving current I_{B}+I_{M} as the temperature of the LD 5 is varied. As shown in FIG. 3A, the slope efficiency decreases as the temperature of the LD 5 increases, where the slope efficiency corresponds to the slop of the optical output power vs current of the LD 5 and corresponds to the ratio of the change of the output power from the LD 5 to the change of the driving current I_{B}+I_{M}. Therefore, the APC circuit 13 increases or decreases the bias current I_{B} as the reference temperature T_{LC} increases or decreases to keep the extinction ratio of the LD constant to the temperature. FIG. 3B is a relation between the reference temperature T_{LC} and the bias current I_{B}. This relation is stored in the memory 35 by the form of the coefficients of a function showing this behavior or the form of the look-up-table. The APC circuit 13 determines the bias current I_{B} as accessing the memory 35.

Thus, the optical transmitting module 1 monitors the temperature of the LD 5 by the first sensor 7 and maintains the temperature of the LD 5 to be the reference temperature TLC by controlling the driving current supplied to the Peltier element 3 such that the difference between the temperature signal output from the first sensor 7 and the reference temperature becomes equal. According to the present control, the reference temperature T_{LC} for the LD 5 is varied based on the ambient temperature sensed by the second sensor 17, the Peltier element 3 may be driven within its operable range even for the wide range of the ambient temperature. Moreover, the APC circuit 13 adjusts the bias current I_{B} supplied to the LD based on the reference temperature T_{LC}, the extinction ratio for the optical signal may be kept constant even the temperature of the LD changes.

Next, the present optical transmitter will be compared with a conventional one.

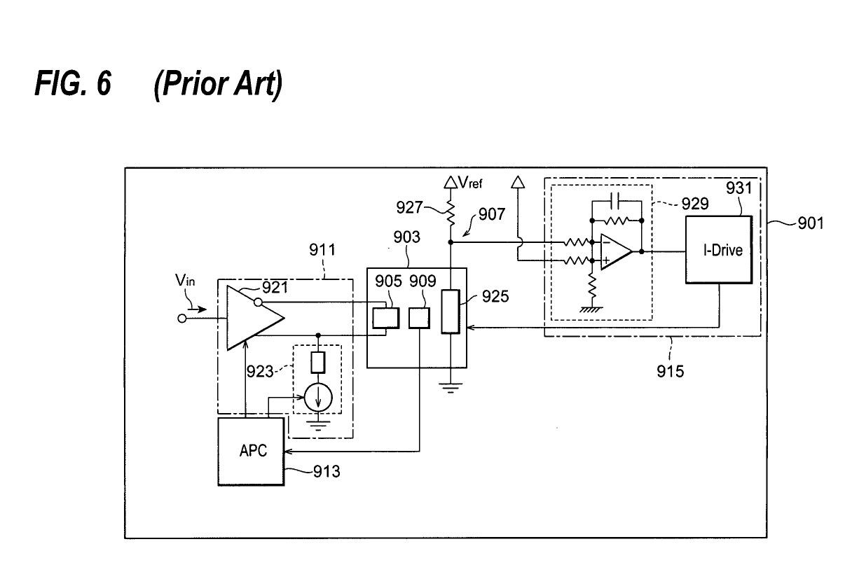

FIG. 6 is a block diagram of the conventional module. The conventional module 901 shown in FIG. 6 has features different from the present module 1. That is, the LD 905 of the conventional module is controlled in its temperature to be constant regardless of the change of the ambient temperature and the temperature sensor 907 only senses the temperature of the LD 905. The conventional module 901 comprises the LD 905 mounted on the Peltier element 903, a Peltier driver 915 to keep the temperature of the Peltier element 903 to be equal to T^{(const)}, a driver 911 to supply the driving current I_{B1}+I_{M1} to the LD 905, and an APC circuit 913 to control the modulation current I_{M1} such that the optical output power from the LD monitored by a photodiode 909 is maintained constant. Since the temperature of the LD is kept constant, the bias current I_{B1} is fixed to be a preset value I_{B}^{(const)} by the APC circuit 913.

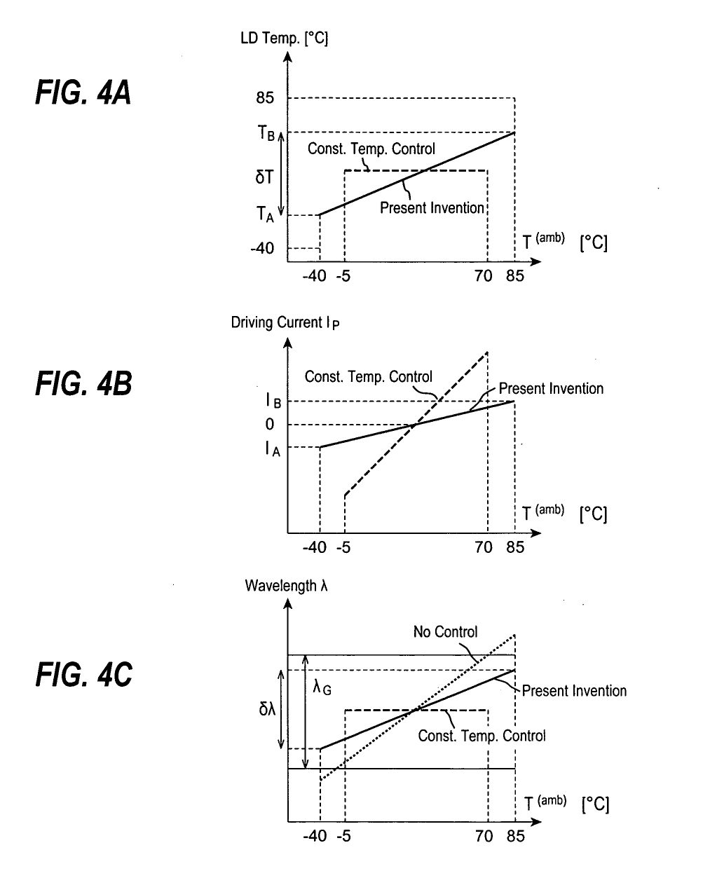

FIG. 4A compares the temperature of the LD and the ambient temperature T^{(amb)}, FIG. 4B compares the relation between the ambient temperature T^{(amb)} and the driving current I_{P} for the Peltier element, and FIG. 4C compares the ambient temperature T^{(amb)} and the emission wavelength λ of the LD.

As shown by the broken line in FIG. 4A, the conventional module 901 controls the temperature of the LD by monitoring only the temperature thereof without sensing the ambient temperature T^{(amb)}. Accordingly, the operable range of the conventional module is restricted within a range where the Peltier element does not show any thermal runaway. For example, when the desired emission wavelength is obtained at 40° C. of the temperature of the LD, the convention module may be operable only between −20° C. to 80° C., practically from −5° C. to +70° C. from the viewpoint of the reliability of the Peltier element. On the other hand, the present module 1 may vary the temperature of the LD in the range from T_{A} to T_{B} (−40° C.<T_{A}<T_{B}<85° C.) when the ambient temperature T^{(amb)} varies from −40° C. to 85° C. That is, the present module is operable within the ambient temperature range δT specified by the standard.

As shown in FIG. 4B, the present module 1 supplies the driving current I_{P} within the range from I_{A} to I_{B} (I_{A}<0<I_{B}), thereby stabilizing the operation of the Peltier device without any thermal runaway even the ambient temperature widely varies from −40° C. to 85° C.

Moreover, as shown in the sold line in FIG. 4C, the variation δλ of the emission wavelength of the present module 1 reduces compared to that of conventional module, dented by the dotted line in FIG. 4C, without any temperature control for the LD. In particular, the relation between the ambient temperature T^{(amb)}and the temperature of the LD is controlled such that the variation of the emission wavelength δλ becomes smaller than 10 nm, which is the grid interval λ_{G} in the CWDM system. Thus, even the ambient temperature varies from −40° C. to 85° C., the present module 1 can reliably transmit the optical signal in the CWDM system.

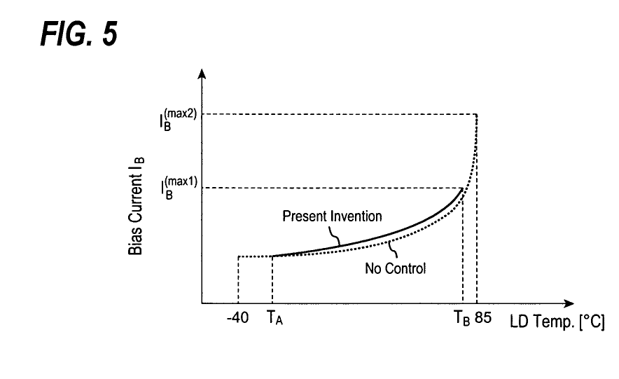

FIG. 5 shows the relation of the bias current I_{B} of the LD and the temperature thereof as comparing the present module 1 and the conventional one. As shown in FIG. 5, the present module 1 may reduce the operable temperature range δT of the LD. Accordingly, even the LD is controlled so as to maintain the extinction ratio thereof constant, the maximum bias current I_{B}^{(max1)} supplied thereto may be reduced compared to the maximum current I_{B}^{(max2)} for the convention module without any temperature control, which also reduces the power consumption of the LD.

Although a preferred embodiment of this invention has been described herein, various modifications and variations will be apparent to those skilled in the art without departing from the spirit or scope of the invention. For example, although the reference generator 19 sets the reference temperature so as to linearly depend on the ambient temperature T^{(amb)}, various relations with the nonlinear function such as quadratic and logarithmic relations may be applied as long as the range of the reference temperature T_{LC} becomes smaller than that of the ambient temperature T^{(amb)}. Thus, it is intended that the present invention cover the modifications and variations of this invention provided that they come within the scope of the appended claims and their equivalents.

What is claimed is:

1. An optical transmitting module, comprising:
a laser diode for emitting light with an emission wavelength;
a Peltier element for controlling a current temperature of the laser diode;
a first temperature sensor for sensing the current temperature;
a Peltier driver configured to receive the current temperature from the first temperature sensor, to compare the current temperature with a reference temperature, and to supply a driving current to the Peltier element, wherein the Peltier driver, the first temperature sensor and the Peltier element constitutes an automatic temperature control loop to set the current temperature of the laser diode to be the reference temperature;
a second temperature sensor for sensing an ambient temperature of the optical transmitting module and outputting a second signal; and
a reference generator configured to receive the ambient temperature from the second temperature sensor and to output the reference temperature to the Peltier driver,
wherein the reference temperature for the laser diode in a range thereof is smaller than an operable range of the ambient temperature.

2. The optical transmitting module according to claim 1,
wherein the range of the reference temperature of the laser diode is smaller than 100° C.

3. The optical transmitting module according to claim 2,
wherein a variation of the emission wavelength of the laser diode is smaller than 10 nm with respect to the operable range of the ambient temperature.

4. The optical transmitting module according to claim 1,
wherein a difference between the reference temperature of the laser diode and the ambient temperature is smaller than 50° C.

5. The optical transmitting module according to claim 1,
further comprises
a photodiode configured to monitor the light emitted from the laser diode and to output a monitored signal, and
a driver configured to receive the monitored signal from the photodiode and to supply a bias current and a modulation current so as to keep output power from the laser diode constant, wherein the laser diode, the photodiode and the driver constitutes an automatic power control loop,
wherein the reference generator outputs a control signal to the driver such that the drive varies the bias current depending on the ambient temperature.

6. The optical transmitting module according to claim 1,
wherein the reference generator includes a memory for storing data to link the ambient temperature with the reference temperature.

7. The optical transmitting module according to claim 6,
wherein the data stored in the memory has a configuration of a look-up-table.

8. The optical transmitting module according to claim 6,
wherein the data stored in the memory is a set of coefficients of a function that links the ambient temperature with the reference temperature.

9. A method for defining a temperature of a laser diode that emits light with an emission wavelength and installed in an optical transmitting module, the method comprising steps of:
(a) sensing a current temperature of the laser diode by a first temperature sensor;
(b) sensing an ambient temperature of the optical transmitting module by a second temperature sensor;
(b) calculating a reference temperature of the laser diode by a reference generator such that a range of the reference temperature of the laser diode is smaller than a range of the ambient temperature;
(c) comparing the reference temperature with the current temperature of the laser diode; and
(d) driving a Peltier element mounting the laser diode, by a Peltier driver, such that a difference between the reference temperature and the current temperature disappear.

10. The method according to claim 9,
wherein the calculation of the reference temperature carried out by the reference generator is based on data that is a set of coefficient of a function to link the ambient temperature to the reference temperature.

11. The method according to claim 9,
wherein the calculation of the reference temperature carried out by the reference generator is based on data that has a configuration of a look-up-table.

12. The method according to claim 9,
wherein the range of the reference temperature of the laser diode is smaller than 100° C.

13. The optical transmitting module according to claim 12,
wherein a variation of the emission wavelength of the laser diode is smaller than 10 nm with respect to the range of the ambient temperature.

14. A method for defining a temperature of a laser diode installed in an optical transmitting module, comprising steps of:
(a) sensing a current temperature of the laser diode by a first temperature sensor;
(b) sensing an ambient temperature of the optical transmitting module by a second temperature sensor;
(b) calculating a reference temperature of the laser diode by a reference generator such that a difference between the reference temperature of the laser diode and the ambient temperature is smaller than 50° C.; and
(c) comparing the reference temperature with the current temperature of the laser diode and driving a Peltier element mounting the laser diode, by a Peltier driver, such that a difference between the reference temperature and the current temperature disappear.
